(19) United States
(12) Patent Application Publication
(10) Pub. No.: US 2008/0183514 A1
(43) Pub. Date: Jul. 31, 2008

(54) System and Methods for Using Solution Building Blocks

(75) Inventors: Ingrid Moulckers, Austin, TX (US); Robert A. Hood, Boca Raton, FL (US); Denise E. Frey, Rochester, MN (US); Ying Huang, Yorktown Heights, NY (US); Westley M. Clavey, Houston, TX (US); Stephen E. Bello, Austin, TX (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 11/668,141

(22) Filed: Jan. 29, 2007

(51) Int. Cl. G06F 9/44

(52) U.S. Cl. 705/7

(57) ABSTRACT

A method for creating and delivering customer solutions includes analyzing a customer's requirements; selecting at least one solution building block as part of a customer solution; and delivering at least one customer solution. The at least one solution building block comprises a preconfigured bundle of at least one asset comprising at least one of a hardware product, software product, service, or another solution building block. The at least one solution building block has been at least one of previously tested or successfully deployed in a customer environment for solving a business, infrastructure, or application problem.

### I. FIELD OF THE INVENTION

This invention relates to a system and methods for customer solution design, sales, delivery, and support using at least one solution building block.

### II. BACKGROUND OF THE INVENTION

Customer solutions are delivered as a customized combination of products, assets, and services. In almost every case, however, the solution and its design are unique. Solutions are ordered, fulfilled, and delivered as piece parts. There is very little reuse of proven patterns, systems, software, hardware, or service assets.

In addition, different versions and modifications of a solution are difficult to manage. There is no tooling to manage solution lifecycles or the components that comprise them. Even when software applications, hardware, or executable logic are listed based upon function and dependencies, a software vendor (SV) or system integrator (SI) still has to select the individual parts or components to assemble a solution to a business or infrastructure problem. Consequently, solution creation and assembly occurs on a micro-level. There is no utilization of specific solutions to business or infrastructure problems that have been previously tested and/or successfully deployed in a customer environment on a macro-level. Without a data structure to support such tested and/or successfully deployed solutions, guided selling, licensing, cross-brand configuration, and consolidated orders and invoices are not feasible.

U.S. Patent Application Publication No. 2006/0230389 A1 discloses a method for specifying business solution requirements. A potential solution is divided in requirement elements. Requirement elements include, but are not limited to, hardware, executable logic, or modules, for performing specific functions, user manuals and other documentation corresponding to particular hardware and modules. Each requirement element is categorized into a corresponding requirement descriptor, each of which is comprised of metadata. Metadata includes, but is not limited to, information about the corresponding industries, integration points between elements, solution areas, criteria depending upon experiences of typical users, and any dependencies the element may have upon other elements. Metadata is stored in a storage means and employed by a Solutions Runtime and Value Assets Assembly (SRVAA) toolset to generate a solution package that address the business problem. The stored metadata and the corresponding elements may be employed in future generation of business solution requirements associated with other business problems.

U.S. Patent Application Publication No. 2006/0230383 A1 discloses a Solutions Runtime and Value Assets Assembly (SRVAA) toolset. The toolset includes a listing of available hardware and software components, along with information on each components functions and dependencies. This information is stored in character files, along with information about relevant industries, integration points between components, solution areas or any other criteria depending upon experiences of typical users of the toolset. A deployment package can be assembled for a particular business such that the business is assured that the package includes all required business functionality relating to a particular business problem without unnecessary components. Components include, but are not limited to, hardware, executable logic, or modules, for performing specific functions, setup and installation scripts, user manuals and other documentation.

U.S. Patent Application Publication No. 2006/0230382 A1 discloses a method for creating business solutions components in a manner that enables the components to be reusable among multiple business solutions. Two potential types of components include “off-the-shelf” software or hardware products and custom products developed for other projects and stored in a component library. Each component is assigned to one or more categories based upon attributes such as the business problems that the particular component addresses. Categories are also based upon criteria such as particular industries associated with a component, integration points between components, solution areas and the experiences of typical users. Categories enable interdependencies among components to be defined so that, for example, a component that includes executable logic can be associated with a component that includes a corresponding user manual. Also provided are means for managing practice manifests describing the categories assigned to business assets associated with each category.

U.S. Patent Application Publication No. 2004/0236853 A1 discloses a method of creating an activation solution for commercial network services. The method employs modular, reusable building block archive files, which represent a higher level of abstraction than simple atomic tasks. After the building block archives files suitable for addressing the needs of an activation solution are selected, innovative logic combines these building block archives to more quickly create an activation solution than is possible working from individual atomic tasks.

U.S. Patent Application Publication No. 2004/0181418 A1 provides flexible implementation of business logic in a business application. The invention relates to a computing environment in which source code is used to implement applications and programs desired by a user. General and reusable business logic is implemented such that customized solutions for business applications are easier to develop. Binding properties in business entities to various logic implementations is utilized to reuse the business logic. Parameters can be set up in metadata that control the behavior of the business logic implementations.

### III. SUMMARY OF THE INVENTION

In an aspect of the invention, a method is provided for creating and delivering customer solutions. A customer's requirements are analyzed, and at least one solution building block is selected as part of a customer solution. The at least one solution building block comprises a preconfigured bundle of at least one asset comprising at least one of a hardware product, software product, service, or another solution building block. In addition, the at least one solution building block has been at least one of previously tested or successfully deployed in a customer environment for solving at least one of a business, infrastructure, or application problem. The at least one customer solution is delivered.

In another aspect of the invention, the at least one solution building block is tracked with a version identifier. The at least one solution building block may be modified and assigned a new version identifier.

In another aspect of the invention, a system is provided that includes an agent for preparing at least one customer solution comprising at least one solution building block and a searchable repository comprising the at least one solution building block. The agent comprises at least one client selected from the group consisting of an order client, a search engine, a design client, a financing client, a delivery client, and a post-sales support client.

In another aspect of the invention, a computer program product is provided comprising a computer useable medium having a computer readable program. When executed on a computer, the computer readable program causes the computer to analyze a customer's requirements; select at least one solution building block as part of a customer solution; and deliver at least one customer solution to the customer. The at least one solution building block comprises a preconfigured bundle of at least one asset comprising at least one of a hardware product, software product, service, or another solution building block. The at least one solution building block has been at least one of previously tested or successfully deployed in a customer environment for solving at least one of an infrastructure problem or business problem.

### IV. BRIEF DESCRIPTION OF THE DRAWINGS

FIG. 1 is a block diagram of a solution building block according to an embodiment of the invention.

FIG. 2 illustrates a lifecycle of a solution building block according to an embodiment of the invention.

FIG. 3 illustrates a method of preparing a customer solution according to an embodiment of the invention.

FIG. 4 is a block diagram of a system according to an embodiment of the invention.

FIG. 5 illustrates an agent according to an embodiment of the invention.

### V. DETAILED DESCRIPTION OF THE DRAWINGS

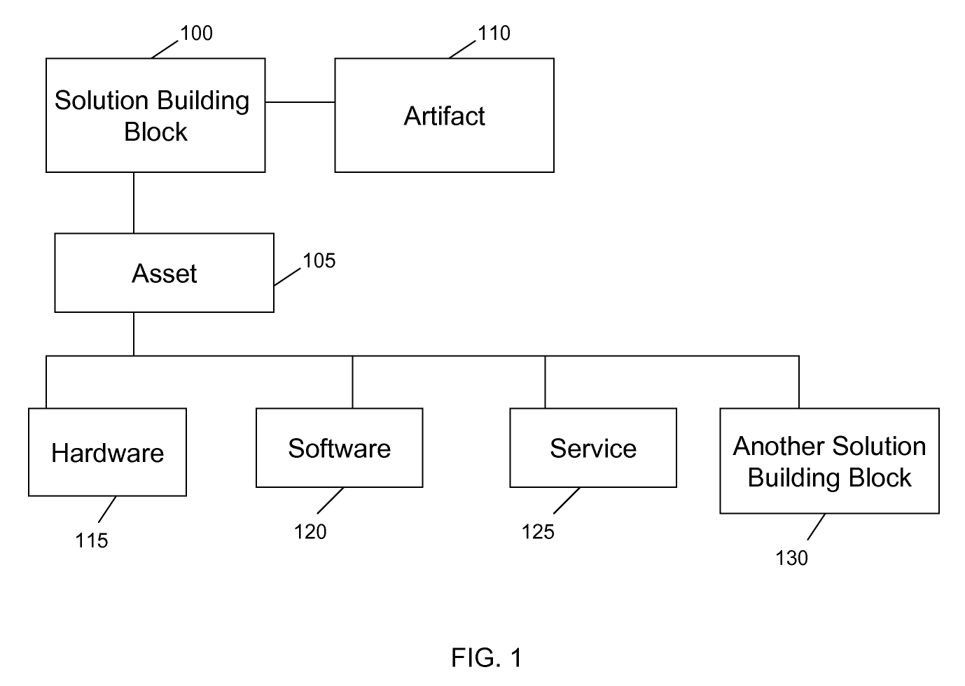

As shown in FIGS. 1-5 the invention is directed to a system and methods of using at least one Solution Building Block (SBB) to efficiently deliver high quality, customer solutions to market. In this detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

### I. Content of SBB

A Solution Building Block (SBB) comprises a preconfigured and interoperable combination or bundle of at least one asset. An SBB may also be associated with at least one artifact. In embodiments, an SBB has been previously-tested and/or successfully deployed in a customer environment to solve at least one of an infrastructure problem, a business problem, or an application problem. Thus, proven SBBs allow for better reuse of assets and/or artifacts and simplify the generation of solutions for customers.

An SBB primarily enables at least one of business solutions, infrastructure solutions, or application solutions, as opposed to having a stand alone value. Thus, an SBB provides customers with pre-integrated and tested functions that address their business, infrastructure, or application needs with less customization than a team of experts or a bag of separate parts provides. A customer solution may comprise at least one SBB.

As shown in FIG. 1, an SBB 100 includes at least one asset 105, preferably two or more assets. Assets are components that may have an independent existence. Assets may include, but are not limited to, at least one of a hardware product 115, a software product 120, a service 125, or another SBB 130. Hardware products may include, but are not limited to, at least one of a server, cluster, printer, personal computer, handheld device, cellular telephone, personal digital assistant, ethernet card or retail system. Software products may include, but are not limited to, at least one of an operating system, application, middleware, or infrastructure software. A service may include, but is not limited to, at least one of a consulting service, fixed scope service, hardware maintenance service, or software support service. A fixed scope service is a type of service which includes a list of documented tasks to be done for a customer, usually in a contract or a statement for specific work. In embodiments, an SBB may include a minimal fixed set of (scoped) tasks to get the SBB to operate.

Each asset of an SBB maintains its integrity, thereby allowing for easier creation and modification of the SBB. The at least one asset may be associated with different corporations or manufacturers. In embodiments, the at least one asset of an SBB may be entitled to normal warranty and support.

As shown in FIG. 1, an SBB 100 may be associated with at least one artifact 110. Artifacts are components that have a dependent existence, such as components having at least one of maintenance, support, sales, content, or delivery functions. The at least one artifact may be part of the SBB or may be separate from the SBB. In addition, the at least one artifact alone may not be delivered to a customer as part of a solution. In embodiments, the at least one artifact may provide support and/or maintenance for the at least one asset.

In embodiments, the at least one artifact includes, but is not limited to, at least one of (1) thought leadership materials; (2) sales and marketing materials; (3) solution architecture; or (4) delivery materials.

Thought leadership materials may include, but are not limited to, at least one of best practices, strategic views, issue specific views, client/customer surveys, or value realization.

Sales and marketing materials may include, but are not limited to, at least one of sales and marketing information, case studies, customer references, whitepapers, FAQs, selling guides, sales kits, presentations, web lectures, customer reference materials, playbooks, fact sheets, statements of work, demonstrations, or sales enablement materials.

Solution architecture may include, but is not limited to, at least one of architecture documentation, method architecture work products, rational unified process architecture artifacts, component business models, business process models, or business process maps. Solution architecture software and hardware may include, but are not limited to, at least one of program products (hardware and software), pre-integrated software bundles, code, software documentations, or partner content.

Delivery materials may include, but are not limited to, at least one of prices (e.g., price of SBB), terms and conditions (e.g., warranty options, billing options, delivery options, upgrades), solution configuration files, test cases, engagement models, project plans, implementation methods, support documentation, roadmaps, delivery enablement materials, technical training materials, client training materials, skill maps, redbooks, configuration and sizing tools, statement of work, assembly tests, client diagnostics, benchmark studies, or hosting delivery options. In embodiments, an SBB that is deployed into a customer environment may become subject to ongoing support and maintenance under the Terms and Conditions of an SBB contract or support agreement with a customer.

The at least one asset and any associated artifacts may be removable or substitutable. Further, an existing SBB or any component thereof may be customized and, as discussed below, the resulting modified or updated SBB may be recaptured as a new SBB.

### II. Lifecycle of SBBs

An SBB may be developed in different ways. For example, an SBB may be created by a development team. Alternatively, an SBB may be created from at least one customer engagement in which at least one asset and any artifacts are identified and proven. Thus, the at least one asset and any associated artifacts are harvested from the customer engagement. Another way in which SBBs may be created is through laboratory development, in which the original ideas come from market intelligence, team experience, or other inspiration. In embodiments, an SBB may be created from existing SBBs that have been previously tested and/or successfully deployed in a customer environment. A customer solution may include at least one SBB created by at least one of these ways or any combination thereof.

Every SBB is tracked from its inception to the end of its supported life with a version identifier. In embodiments, an SBB may be a certified, base version SBB. The base version of an SBB may be modified, for example, to suit a specific customer's needs. The modified SBB is assigned a new version identifier. The new, modified SBB may inherit many or all of the properties and content from the base version SBB.

When a base version SBB or a modified SBB becomes part of a specific customer solution, it is also given a solution identifier (identifying a technical solution and all pertinent information about the specific problems associated with the solution). When a base version SBB or a modified SBB becomes part of a specific customer engagement, it is also given an engagement identifier (identifying the particular customer engagement or contract).

As a customer solution design, sales, and delivery cycle continues, an SBB may be further configured to support the customer's needs. For example, an SBB may be updated periodically. An SBB may be updated when errors are detected within a customer's environment or from a third party integrator. Additionally, an SBB may be updated when enhancements are identified, when a new asset or artifact becomes available, or when an existing asset and artifact becomes unavailable. Each time an SBB is modified, updated, or purchased as part of a customer solution, it may be given at least one of a new version identifier, new solution identifier, or new engagement identifier.

An SBB may undergo at least one type of testing. Development/Functional Testing is an automated process for enabling reuse of SBBs and for maintaining current assets and/or artifacts in an SBB. Integration Testing ensures that the at least one asset and any artifacts integrate and interoperate as intended by testing scenarios and solutions. In embodiments, the Integration Testing may be delivered to customers to enable them to test an SBB and any solution.

Performance Testing ensures that the SBB delivers appropriate performance levels by using test drivers and monitoring tools. The Performance testing may evolve over time. In embodiments, the Performance Testing may be delivered to customers. Business Infrastructure Solution Testing ensures that the SBB can operate in support of industry business and/or infrastructure solutions.

The at least one type of testing may occur at any time during the lifecycle of an SBB, such as during at least one of SBB creation, SBB modification, or SBB updating. The at least one type of testing validates or certifies each SBB. In embodiments, the testing may also be done by a customer or a third party integrator, thereby allowing for greater variability in customer solutions.

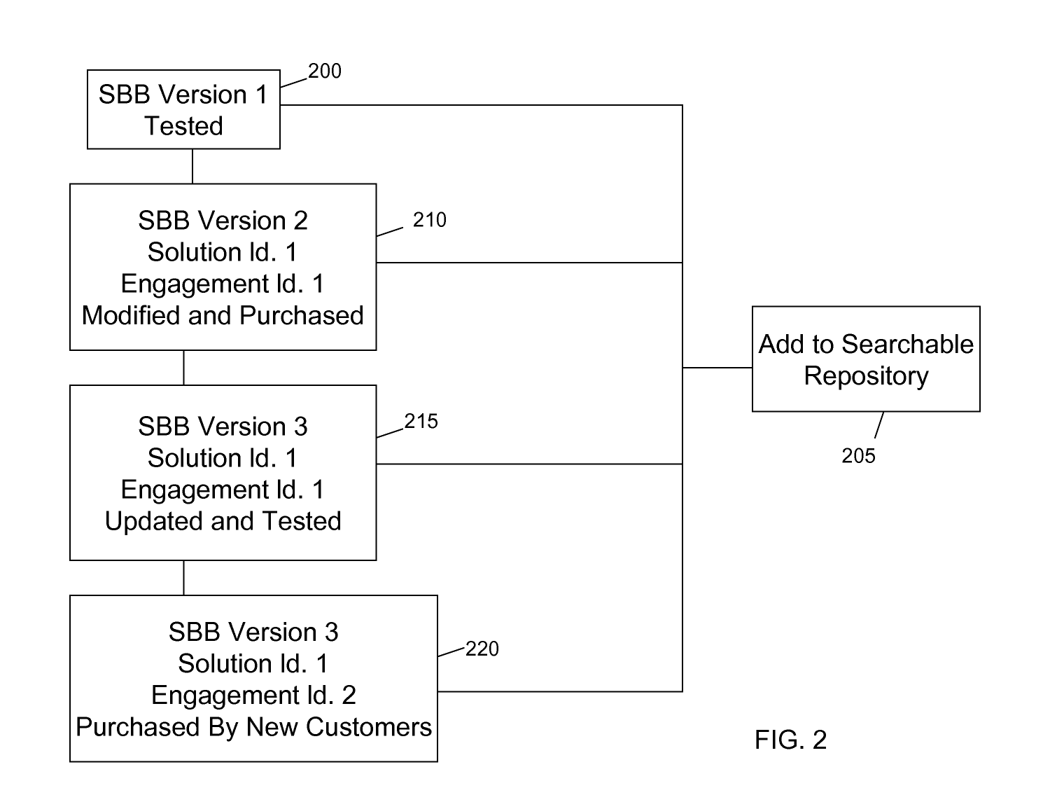

The lifecycle of an SBB is illustrated in FIG. 2. A base version 1 of an SBB is tested, 200, and added to a searchable repository, 205. The base version is modified, purchased, and deployed in a customer environment, 210. Thus, the modified SBB is given a new version identifier (version 2) as well as a solution identifier (identifying a solution and information about the problems associated with the solution) and an engagement identifier (identifying the particular customer engagement). In addition, the modified SBB is added to the searchable repository, 205. The modified SBB version 2 is updated and tested, 215. The updated SBB is given a new version identifier (version 3); however, the solution identifier and the engagement identifier remain the same. The updated SBB is added to the searchable repository, 205. The updated SBB is purchased by a new customer to address the same problem, 220. Thus, the SBB is given a new engagement identifier; however, the version identifier and the solution identifier remain the same. The SBB is added to the searchable repository, 205. The searchable repository will be explained in greater detail below.

### III. Repository of SBBs

An SBB is given a metadata definition and stored as machine-readable, reusable asset specification (RAS) file in a searchable repository or database. In embodiments, metadata may define at least one of (1) the SBB; (2) the at least one asset; (3) any associated artifact; or (4) the problems the SBB solves, for example, the business, infrastructure, or application requirements associated with the SBB. Thus, a metadata definition may include, but is not limited to, at least one of description, feature code, model type, model number, name, version identifier, solution identifier, engagement identifier, customer identifier, third party identifier, assets, artifacts, dependencies on other SBBs, or the like.

A metadata definition also defines how to find each RAS file. In embodiments, each RAS file may be linked to other files in the searchable repository. For example, RAS files may be structured in a parent-child relationship.

In embodiments, there may be different classes of repositories working in unison to support the lifecycles of SBBs. For example, an SBB Development Repository may support the construction or bundling of at least one asset and any associated artifact. An SBB Data Repository may hold and manage relational information of different SBBs. An SBB Publication Repository may link the data elements of SBBs with the asset/artifact information and provide the metadata for finding and using SBBs. In embodiments, a repository may be built using IBM's Tivoli Tools and may be accessed via tooling such as IBM's WebSphere Portal or Rational Software Development Platform.

In embodiments, at least one repository comprises previously tested and/or successfully deployed SBBs. The searchable, machine-readable RAS files allows for identification and design of customer solutions for a variety of problems and environments.

### IV. Preparing a Customer Solution

According to the invention, the creation and design of customer solutions resembles an assembly process, as opposed to a new application development process.

Preparing a solution comprises analysis of customer requirements based upon needs and criteria provided by a customer. Based upon that analysis, at least one SBB is selected by searching a repository comprising a catalog of previously-tested and/or successfully deployed SBBs. For example, the selection of the at least one SBB may be made using metadata comprising at least one of description, version identifier, solution identifier, or engagement identifier of an SBB. In embodiments, the identification and design of customer solutions may be partially or fully automated based upon the criteria provided a customer.

In embodiments, preparation of a customer solution may also include at least one of (1) checking terms and conditions; (2) checking SBB pricing; (3) performing a credit check; (4) preparing a customer contract; (5) preparing scheduling and delivery of at least one solution; (6) preparing billing and invoicing; (7) preparing supporting documentation for the solution; or any combination thereof.

A solution comprising at least one SBB may be offered to the customer. In embodiments, two or more solutions may be presented to the customer, each solution having a different cost based upon its components. The solution may be sold directly to the customer or may be sold to third parties which may use the SBB to package their own solution offering.

In embodiments, an SBB may support role-based access depending upon the status of a customer or third party. For example, an internal user may have access to all functionalities of the SBB. A heavy licensee may have greater access than a light licensee, but less access than an internal user. The role-based access may also be used to control who can view or edit the at least one asset and any artifact within the SBB. For example, if an SBB contains a third party service, the third party may require continued controlled access to artifacts to provide support and maintenance to the SBB.

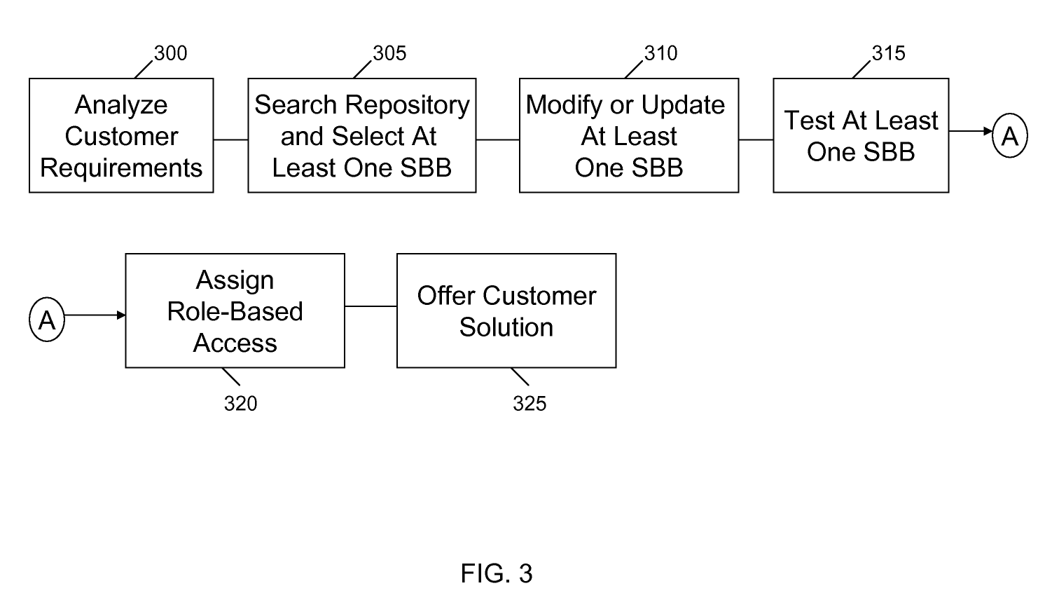

A method of preparing a customer solution is illustrated in FIG. 3. A customer's requirements are analyzed based upon needs and criteria provided by the customer, 300. Based upon this analysis, at least one SBB is selected by searching a repository of previously tested and/or successfully deployed SBBs, 305. If necessary, the at least one SBB is modified or updated according to the customer's requirements, 310. The at least one SBB is tested, 315. The at least one SBB is assigned role-based access, 320. A customer solution comprising the at least one SBB is offered to the customer, 325.

### V. System and Tooling of SBBs

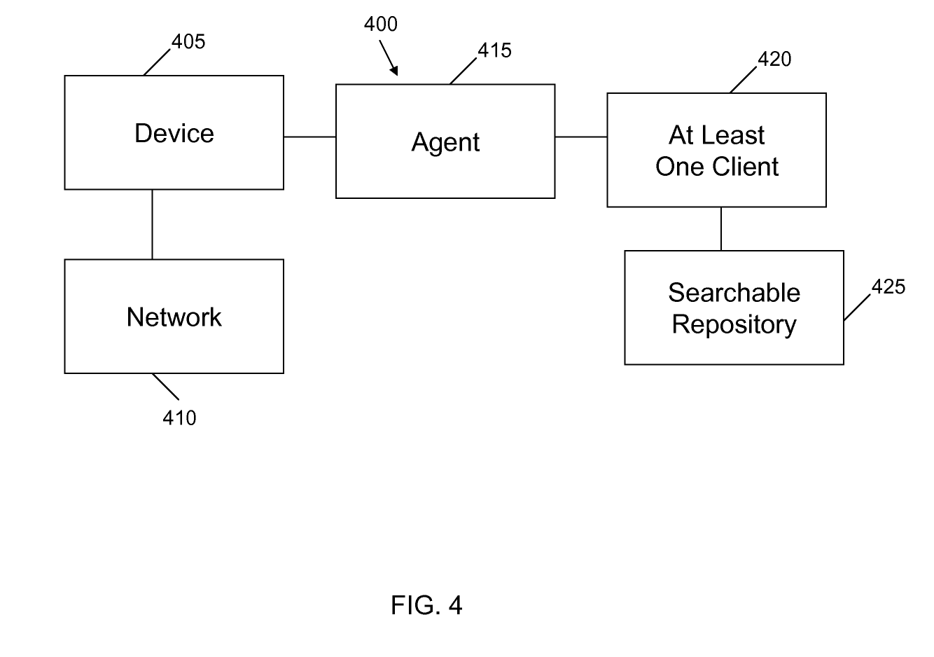

FIG. 4 is a block diagram showing an illustrative system of the invention, denoted by 400. The illustrative system includes at least one electronic or digital device 405 (e.g., mainframe computer, a personal computer, personal digital assistant or PDA). The at least one device may be connected to a network 410 (e.g., the Internet, local area network (LAN), wide area network (WAN)). In embodiments of the invention, the system includes an agent 415, comprising at least one client 420, for preparing a customer solution comprising at least one solution building block. The at least one solution building block may be stored in at least one searchable repository 425. The agent and at least one client may be applications residing on the at least one electronic or digital device or on a server. The illustrative system is but one example, and one of ordinary skill in the art would recognize that many other variations may exist, all of which are contemplated by the invention.

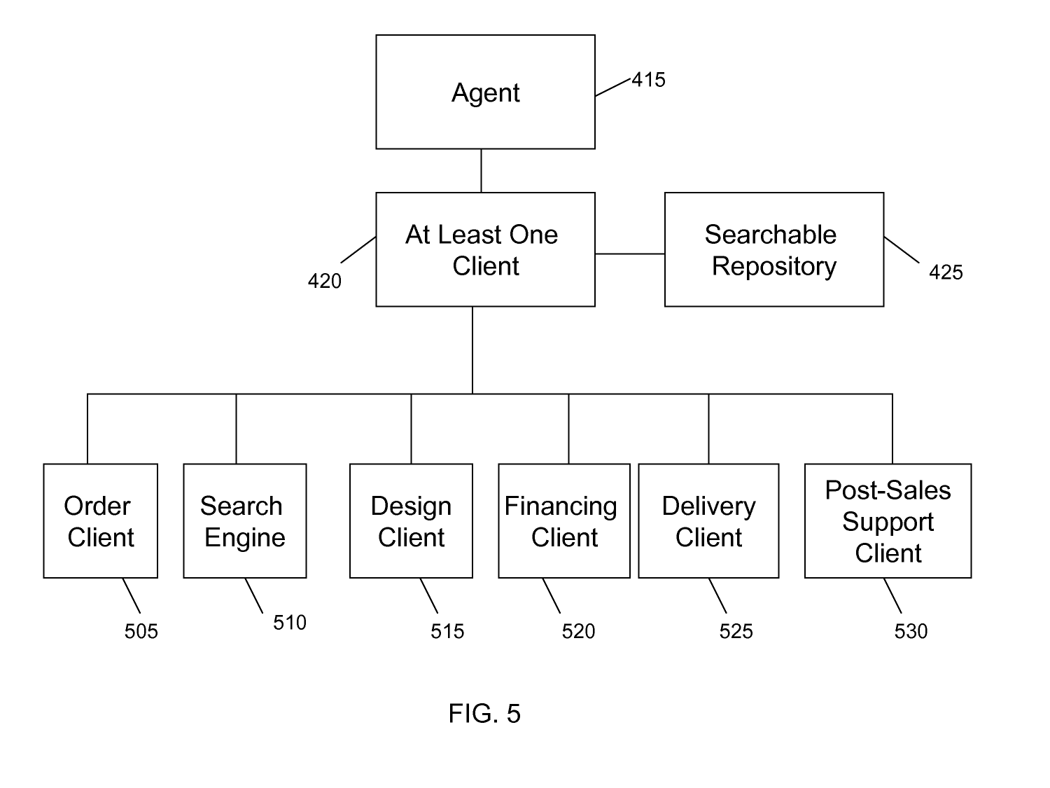

FIG. 5 illustrates an exemplary agent 415 of the invention which includes at least one client 420 comprising an order client 505, a search engine 510, a design client 515, a financing client 520, a delivery client 525, a post-sales support client 530, or any combination thereof. In embodiments, the search engine 510 may reside on a separate server, either its own server or the server on which the searchable repository 425 resides.

In embodiments, an order client 505 may analyze a customer's requirements (e.g., a business, infrastructure, or application problem) based upon criteria provided by the customer. The order client 505 may also analyze the terms and conditions of any customer engagement as well as performing credit checks. A search engine 510 searches at least one repository for at least one SBB. The search engine may be any search engine capable of locating an SBB. A design client 515 allows for the modification, revision, updating, testing, and storing of any asset, artifact, or SBB. A financing client 520 handles at least one of pricing (e.g., cost of the SBB), billing, invoicing, or licensing. A delivery client 525 schedules and executes delivery of at least one customer solution and may include preparing a customer contract. A post-sales support client 530 determines the types of support (e.g., documentation, warranty options) that may be needed once an SBB is deployed in a customer environment.

As illustrated in FIG. 3, an order client may analyze customer requirements. The search engine may search a repository and select at least one SBB based upon the analysis of the customer requirements. The design client may update or modify the at least one SBB, any asset, or artifact as required. The design client may also test the at least one SBB. The delivery client may assign role-based access to the at least one SBB and any corresponding customer solution, as well as scheduling and executing delivery of at least one customer solution.

Each client may comprise at least one role-based tooling environment. A tooling environment may comprise at least one toolset. In embodiments, a toolset may include, but is not limited to, at least one of IBM Rational Software Development Platform, IBM WebSphere Platform, IBM DB2 Universal Database Platform, Eclipse Platform, IBM Tivoli Tools, Lotus Workplace, office-based tooling from Microsoft, or any combination thereof.

In embodiments, an SBB Owner/Maintainer role-based environment may have access to a toolset comprising at least one of a WebSphere Application Server (WAS) to access a portal comprising SBB information (e.g., SBB Creation Portlet, SBB Update Portlet, Terms and Conditions Access Portlet) and/or a portal comprising RAS Repository information. This toolset enables the building of a community of users.

In embodiments, an SBB Developer role-based environment may have access to a toolset comprising at least one of IBM Rational Software Architect, plug-ins (e.g., web browser, navigator view), SBB-specific UML profiles, RAS perspectives, Eclipse Perspectives, CVS Perspectives, and WBI Modeler. This toolset enables access to and manipulation of the at least one asset and any artifacts that comprise an SBB.

In embodiments, an SBB Manager role-based environment may have access to all clients for managing customer solution design, sales, delivery, and support.

### VI. Types of SBBs

In embodiments, there may be several kinds of SBBs. For clarity, three kinds of generic SBBs will be discussed in the following disclosure. However, it should be understood that other kinds of SBBs are possible. An SBB may be at least one of a business SBB, an application-enabling SBB, or an infrastructure SBB.

A business SBB solves a business problem. A business SBB may be industry specific (e.g., insurance industry, auto production, branch bank transformation). A business SBB may also address a cross industry problem (e.g., human resources). The following is an illustrative, not exhaustive, list of different types of business SBBs:

1. An Anti-Money Laundering SBB may address a bank's need to identify abuse of its facilities.

2. A SCORE (Solution for Compliance in a Regulated Environment) SBB may address compliance with key industry regulations and processes.

3. A Retail EBO (a portfolio of SBBs) may implement a Point of Sale component on top of several Application Enabling and Infrastructure Building Blocks. The Retail EBO is a coordinated effort to develop a set of assets to address retail opportunities. The function that the Retail EBO addresses is providing the infrastructure (hardware and middleware) that enables the remote (Enterprise) management of store environments and support for a set of applications in individual stores.

An application-enabling SBB provides key capabilities to establish a secure, reliable, and scalable application execution environment. The following is an illustrative, not exhaustive, list of different types of application-enabling SBBs:

1. An Enterprise Service Bus SBB provides a common integration infrastructure, typically based on open web services standards, but adaptable to work with existing application interfaces. For example, an Enterprise Service Bus SBB may comprise a combination of middleware addressing the communications for Services Oriented Architectures in Industry Solution engagements.

2. A User Access SBB provides mechanisms to enable differing device types, modes of interaction and connection topologies to seamlessly participate in end-to-end IT based solutions.

3. A User Interaction SBB provides presentation capabilities for a user to interact with a business service or function (e.g., these capabilities may include presentation services, collaboration services, search services, and content subscription services).

4. A Business Process Choreography SBB provides the ability to orchestrate business processes and rules between key business functions, whether the latter are provided by users, applications, or other IT components.

5. A Business Service SBB provides core business functions based on a third party package.

6. A Common Services SBB provides common functional or infrastructure capabilities that are used by more than one service in an application operating environment.

7. An Information Management SBB provides key capabilities to manage and leverage information assets. Information assets may include databases, file systems, data warehouses, or content repositories. The assets may be leveraged through services such as search/access, integration, analysis, content control, or industry specific extensions.

An infrastructure SBB provides key capabilities of an IT or other technology infrastructure solution, and may include making that infrastructure secure, reliable, variable, or automated. The following is an illustrative, not exhaustive, list of different types of infrastructure SBBs:

1. A Utility Business Services SBB provides key capabilities necessary to offer IT resources and capabilities as commercial On Demand Services on a subscription basis, in accordance with a utility computing business model.

2. An SLA and Orchestration SBB provides key capabilities to simplify management of infrastructure. These capabilities may include integrated configuration, administration, security, availability, and problem management. The SBB may also include automation such as workload management.

3. A Resource Visualization SBB provides key virtualization capabilities to manage infrastructure capacity inline with demand. All kinds of resources can be virtualized including at least one of network, server, or storage.

In embodiments, an SBB may include providing at least one of (1) Configuration and installation of offerings/components (e.g., runtime, build-time, admin); (2) Tools (e.g., integrated tools for developing); (3) Best practices; (4) Hints; or (5) Tips/Samples.

The invention can take the form of an entirely hardware embodiment, an entirely software embodiment, an entirely services embodiment or an embodiment containing any combination of hardware, software, and services elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowcharts or block diagrams.

### EXAMPLES

### I. Business Solution Building Blocks

A. Retail EBO Building Block

The following is an illustrative list of SBBs for a Retail EBO:

| SBB | Type |
|---|---|
| Store Appliance BB: combination of middleware, OS and hardware | Application |
| that can be “dropped” into the Store. Supports multiple | Enabling BB |
| applications. | |
| Device BB: combination of application, middleware and hardware | Industry Specific |
| for specific devices (e.g., cash register, kiosk, etc.) | BB |
| Distributed Enterprise Application Management: Tivoli software + policies | Infrastructure BB |
| for managing distributed Store environments | |
| Retail Open POS BB: application combined with Store Appliance | Industry Specific |
| and Device BB to delivery a Point of Sale capability | BB |
| Guided Selling BB: application combined with Integration Services, | Industry Specific |
| Store Appliance and Device BBs | BB |
| Personal Shopping Assistant BB: application combined with | Industry Specific |
| Integration Services, Store Appliance and Device BBs | BB |
| RFID BB: application combined with Integration Services, Store | Industry Specific |
| Appliance and Device BBs | BB |
| Digital Merchandizing BB: application combined with Integration | Industry Specific |
| Services, Store Appliance and Device BBs | BB |
| Catalog BB: catalog component that can be used in Retail and | Cross Industry |
| other industries | BB |

B. Life Sciences SCORE Building Block

| | |
|---|---|
| Function | Document Management System for regulated documents |
| | Supports key industry regulations and processes, such as GXP |
| | and 21CFR11 compliance and eCTD |
| Products | SCORE Unique Software Components |
| and | DB2 Content Manager |
| Assets | WS Portal Enable |
| | WBI Server Foundation |
| | WSAD - IE |
| | WAS Express |
| | Engagement Assets |
| | Adobe Acrobat, Element Server, Document Server |
| | Documentum |
| | Infodata Annodoc |
| | X-Series, P-Series and Storage |

C. Financial Services Sector Anti Money Laundering (AML) Fraud Protection Building Block

| | |
|---|---|
| Function | The AML SBB supports compliance with |
| | Anti-money laundering legislation |
| Products | BCS Engagement Assets |
| and | Searchspace ISV |
| Assets | DB2 |
| | P-Series |

### II. Application-Enabling Solution Building Blocks

A. ESB (Enterprise Service Bus) in a Box (Application Enabling/ESB BB)

| | |
|---|---|
| Function | The Enterprise Service Bus is the communication control |
| | point for the emerging SOA (services oriented architecture) |
| | based enterprise architectures. The functions include: |
| | Guaranteed delivery transactions, Persistence, Filtering, |
| | Routing, Transforms, Choreorgraphy, Scalability and |
| | Security, Synch, A-synch, batch, Complex event processing |
| Products | Engagement Assets |
| and | Connect |
| Assets | WAS 6.0 |
| | WSG (Websphere Services Gateway) |
| | MB II (Information Integration) |
| | MQ |
| | TAM (Tivoli Access Monitor) |
| | WSAD - IE (Websphere Studio Application Developer) |
| | MQ Console |
| | RSA (Rational Software Architect) |
| | MB Toolkit |
| | Adapter Toolkit |

B. Secure Portal (Application Enabling/User Access BB and User Interaction BB)

| | |
|---|---|
| Function | The Secure Portal comprises a combination of middleware |
| | addressing the portal function in industry solutions |
| Products | WAS |
| and | WPS (Websphere Portal Server) |
| Assets | TAM (Tivoli Access Manager) |
| | Engagement, Installation and Configuration Assets |

C. B2B Gateway (Application Enabling/Business Process Choreography)

| | |
|---|---|
| Function | The Business-to-Business building block addresses the |
| | interactions and collaborations between business processes |
| | in separate enterprises. This can be observed in solutions |
| | that implement programmatic interfaces to connect |
| | inter-enterprise applications. It does not cover applications |
| | that are directly invoked using a user interface by business |
| | partners across organizational boundaries. |
| Products | Version 1: WAS Network Deployment, Websphere Studio, |
| and | Installation and Configuration Assets |
| Assets | Version 2: WDI, WBI, MQ, DB2 |
| | Mid Market Version: WBI Connect Express |
| Business | The B2G Gateway BB decreases time and reduces errors in |
| Status | the installation and configuration of the base products. |

D. Bank Teller Components BB: (Application Enabling/Business Support BB)

| | |
|---|---|
| Function | The Bank Teller Components BB provides fundamental |
| | business functionality (for example, accounting functions) |
| | for use by applications. |
| Products | Business Components |
| and | Documentation |
| Assets | |

E. J2EE Application Enablement (Application Enabling/Common Services BB)

| | |
|---|---|
| Function | The J2EE Application Enablement BB supports the J2EE |
| | program model including database and communications. |
| Products | DB2 |
| and | WAS |
| Assets | MQ |
| Business | The BB decreases time and cost to install and configure the |
| Status | base programming environment. It is the base set of products |
| | needed in almost any ISV related solution implementation. |

F. ECLipz Platform (Application Enabling/Common Services and Information Management BB) and (Infrastructure/SLA and Orchestration BB)

| | |
|---|---|
| Function | eCLipz will provide a key proof point for a strategy around delivering an |
| | improved end-to-end systems experience. A key element of this strategy is |
| | a concept to offer more complete systems that include a choice of pre- |
| | installed and pre-integrated infrastructure software (DB, Web App, Storage |
| | and Systems Mgmt, etc). Combinations of hardware and WAS would deliver |
| | Common Services functionality. Combinations of hardware and DB2 would |
| | deliver Information Management functionality. Combinations of hardware |
| | and Tivoli SW would deliver Orchestration functionality, virtualization and |
| | storage management functionality. |
| Products | WAS, DB2, Tivoli Products |
| and | x, z, and pSeries |
| Assets | IBM Storage |
| | Services assets |

G. Enterprise Content Management (Application Enabling/information Management BB)

| | |
|---|---|
| Function | This Building Block details how to create a document |
| | management system with IBM Content Manager in the |
| | backend and WebSphere Portal as the User Interface for |
| | managing a document through its life cycle. |
| Products | WAS |
| and | WPS |
| Assets | IBM HTTP Server |
| | DB2 |
| | DB2 Content Manager |
| | DB2 Information Integrator |
| | Installation and Configuration assets |
| Business | The BB reduces time to install and configure the Content |
| Status | Management function for Services teams and clients |

### III. Infrastructure Solution Building Blocks

A. IBM Integrated Security Solution for Cisco Networks (SENTRY) (Infrastructure/Utility Business Service BB)

| | |
|---|---|
| Function | SENTRY provides security policy and compliance |
| | management with remediation in Cisco Network environment. |
| | It provides users access to resources while protecting the |
| | resources from inappropriate access or corruption from |
| | non-secure devices. |
| Products | Tivoli Security Compliance Manager |
| and | Tivoli Provisioning Manager |
| Assets | Cisco ACS, Cisco Trust Agent |
| | TIM, TAM and IBM Rescue and Recovery with Antidote |
| | Delivery Manager |
| | Thinkpad, Thinkcenter, Tested e-Server recommended |
| | configuration |
| | Services: Security Healthcheck, Network Security |
| | Assessment, Network Operation Assessment for Cisco |
| | Networks, Network Integration and Deployment Services, |
| | Systems Management Services |

B. DR 550 Compliance Storage (Infrastructure/Utility Business Service BB)

| | |
|---|---|
| Function | DR 550 (and predecessor DR 450) is a pre-integrated building |
| | block that supports a data retention solution (e.g., includes |
| | data retention, disaster protection, strategy/policy |
| | development). |
| Products | Tivoli Storage Manager |
| and | P-Series |
| Assets | FAStT Storage |
| | HACMP |
| | WORM and non-WORM Tape |
| | Documentation |

C. Infrastructure/Resource Virtualization BB

| | |
|---|---|
| Function | The Virtualization Engine BB provides for the virtualization |
| | of resources (servers, storage and networks) in the enterprise. |
| Products | eServer (in particular the Hypervisor, Virtual Lan and Virtual |
| and | I/O facilities) |
| Assets | z/OS, AIX 5L, Linux, i5/OS, Windows |
| | IBM Director Multiplatform |
| | Systems Provisioning |
| | Enterprise Workload Manager |
| | IBM Grid Toolbox for Multiplatform |
| | TotalStorage San Volume Controller |
| | TotalStorage San File System |
| | TotalStorage Productivity Center |

The exemplary and alternative embodiments described above may be combined in a variety of ways with each other. Furthermore, the steps and number of the various steps illustrated in the figures may be adjusted from that shown.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

What is claimed is:

1. A method for creating and delivering customer solutions, comprising:
analyzing a customer's requirements;
selecting at least one solution building block as part of a customer solution; and
delivering at least one customer solution,
wherein the at least one solution building block comprises a preconfigured bundle of at least one asset comprising at least one of a hardware product, software product, service, or another solution building block,
wherein the at least one solution building block has been at least one of previously tested or successfully deployed in a customer environment for solving at least one of a business, infrastructure, or application problem.

2. A method according to claim 1, wherein the at least one solution building block further comprises at least one artifact having at least one of maintenance, support, sales, content, or delivery functions.

3. A method according to claim 1, wherein the at least one solution building block is stored in a searchable repository.

4. A method according to claim 3, wherein the searchable repository comprises metadata that defines at least one of the at least one solution building block, the at least one asset, any artifact, or problems the at least one solution building block solves.

5. A method according to claim 1, wherein the hardware product comprises at least one of a server, cluster, printer, personal computer, handheld device, cellular telephone, personal digital assistant, ethernet card, or retail system.

6. A method according to claim 1, wherein the software product comprises at least one of an operating system, application, middleware, or infrastructure software.

7. A method according to claim 1, wherein the service comprises at least one of a consulting service, fixed scope service, hardware maintenance service, or software support service.

8. A method according to claim 2, wherein the at least one artifact comprises at least one of thought leadership materials, sales and marketing materials, solution architectures, or delivery materials.

9. A method according to claim 1, wherein the at least one solution building block is tracked with a version identifier.

10. A method according to claim 9, further comprising modifying the at least one solution building block and assigning the modified at least one solution building block a new version identifier.

11. A method according to claim 9, wherein once the at least one solution building block becomes part of a customer solution, the at least one solution building block is given a solution identifier.

12. A method according to claim 9, wherein once the at least one solution building block becomes part of a customer engagement, the at least one solution building block is given an engagement identifier.

13. A method according to claim 9, further comprising updating the at least one solution building block is updated.

14. A method according to claim 13, wherein the at least one solution building block is updated when errors are detected, when enhancements are identified, when a new asset or artifact becomes available, or when an existing asset or artifact becomes unavailable.

15. A method according to claim 1, wherein the at least one solution building block supports role-based access.

16. A method according to claim 1, further comprising testing the at least one solution building block.

17. A method according to claim 1, wherein the at least one solution building block addresses a cross industry business problem.

18. A system, comprising:
an agent for preparing at least one customer solution comprising at least one solution building block, said agent comprising at least one client selected from the group consisting of an order client, a search engine, a design client, a financing client, a delivery client, and a post-sales support client; and
a searchable repository comprising the at least one solution building block.

19. A system according to claim 18, wherein the at least one client comprises at least one role-based tooling environment.

20. A computer program product, comprising:
a computer useable medium having a computer readable program, wherein the computer readable program when executed on a computer causes the computer to:
analyze a customer's requirements;
select at least one solution building block as part of a customer solution; and
deliver at least one customer solution to the customer,
wherein the at least one solution building block comprises a preconfigured bundle of at least one asset comprising at least one of a hardware product, software product, service, or another solution building block,
wherein the at least one solution building block has been at least one of previously tested or successfully deployed in a customer environment for solving at least one of an infrastructure problem or business problem.
